(19) United States
(12) Patent Application Publication
(10) Pub. No.: US 2024/0269815 A1
(43) Pub. Date: Aug. 15, 2024

(54) CON ROD

(71) Applicant: Black & Decker Inc., New Britain, CT (US)

(72) Inventors: Tobias HEEP, Steinbach (DE); Jozef BRISSAK, Oravske Vesele (SK); Vaclav KVAPIL, Teplice (CZ)

(21) Appl. No.: 18/642,450

(22) Filed: Apr. 22, 2024

Related U.S. Application Data
(63) Continuation of application No. 17/651,487, filed on Feb. 17, 2022, now abandoned.

(51) Int. Cl. B25D 11/12; B25D 11/06; B25D 17/26

(52) U.S. Cl. CPC B25D 11/12; B25D 11/062; B25D 17/26; B25D 2211/061; B25D 2211/068; B25D 2217/0096

(57) ABSTRACT

A hammer drill is provided including a housing, a motor mounted within the housing, and a hammer mechanism. The hammer mechanism includes a crank plate or a wobble plate driven by the motor, a con rod coupled to the crank plate or the wobble plate, a piston reciprocatingly driven by the con rod along a longitudinal axis, a ram and a beat piece. At least one of the wobble plate or the con rod is made of sintered steel.

### CROSS-REFERENCE TO RELATED APPLICATIONS

This application claims priority, under 35 U.S.C. § 119, to UK Patent Application No. 2100313.2 filed Jan. 11, 2021, which is incorporated herein by reference in its entirety.

### FIELD

The present invention relates to a con rod or a wobble plate for a hammer drill.

### BACKGROUND

A typical hammer drill comprises a body in which is mounted an electric motor and a hammer mechanism. A tool holder is mounted on the front of the body which holds a cutting tool, such as a drill bit or a chisel. The hammer mechanism typically comprises a ram, slideably mounted in a cylinder, reciprocatingly driven by a piston via an air spring, the piston being reciprocatingly driven by the motor via a set of gears and a crank mechanism or wobble bearing. The ram in turn repeatedly strikes the end of the cutting tool via a beat piece. When the only action on the tool bit is the repetitive striking of its end by the beat piece, the hammer drill is operating in a hammer only mode.

Certain types of hammer drill also comprise a rotary drive mechanism which enables the tool holder to rotatingly drive the cutting tool held within the tool holder. In such constructions, the cylinder is typically in the form of a rotatable spindle. This can be in addition to the repetitive striking of the end of the cutting tool by the beat piece (in which case, the hammer drill is operating in a hammer and drill mode) or as an alternative to the repetitive striking of the end of the cutting tool by the beat piece by switching off the hammer mechanism (in which case, the hammer drill is operating in a drill only mode).

EP1157788 discloses such a hammer drill.

Hammer drills typically use one of two types of piston.

The first type of piston is known as a flat piston. A flat piston locates inside of a cylinder or spindle. The ram also mounts directly in the spindle or cylinder directly in front of the flat piston. The air spring formed between the ram and piston is contained within a chamber formed by the front end of the piston, the inner side walls of the spindle or cylinder and the rear of the ram. A flat piston makes has no direct contact with the ram. DE4202767 discloses a hammer drill with a flat piston. Typically, a flat piston is driven by a crank mechanism comprising a crank plate and a con rod. The crank plate is rotatably mounted adjacent the rear of the spindle or cylinder and is rotationally driven by a motor. One end of the con rod is pivotally attached to the plate, the pivot axis being eccentric to the axis of rotation of the plate. The other end of the con rod is pivotally attached to the rear of the piston. The rotational movement of the crank plate is converted into a reciprocating movement of the piston.

The second type of piston is known as a hollow piston. A hollow piston locates inside of a cylinder or spindle. A tubular recess is formed inside of the front of the hollow piston. The ram mounts directly in the recess of the hollow piston. The air spring formed between the ram and piston is contained within the recess and is formed within a chamber formed by inner walls of the recess of the hollow piston and the rear of the ram. A hollow piston is in direct contact with and provides support for the ram. The ram makes no contact with the spindle or cylinder. EP1157788 discloses a hammer drill with a hollow piston. Typically, a hollow piston is driven by a wobble plate. A wobble plate comprises a circular central plate mounted on a shaft, the plane of the plate being located at an angle relative to a longitudinal axis of the shaft. A circular ring is mounted on the plate and surrounds the periphery of the plate such that plane of the ring is parallel to the plane of the plate. The ring can freely rotate around the periphery of the plate. The ring is prevented from rotating. Therefore, as the shaft rotates, the plane of the plate oscillates back and forth in the direction of the longitudinal axis of the shaft. A finger is attached to the side of the ring and extends radially away from the centre of the ring. The end of the finger remote from the ring is attached to the rear of the piston. As the shaft rotates and the plane of the plate oscillates back and forth in the direction of the longitudinal axis of the shaft, the finger also oscillates back and forth in the direction of the longitudinal axis of the shaft, reciprocatingly driving the piston.

Pistons and con rods used in hammer drills are typically constructed from aluminium or plastic. WO03/041915 describes a hammer mechanism with a plastic con rod.

A prior art design of hammer mechanism will new de described with reference to FIGS. 1 to 5.

Referring to FIG. 1, a hammer drill comprises a body 2 having a rear handle 4 moveably mounted to the rear of the body 2. The rear handle 4 comprises a centre grip section 90 and two end connection sections 92; 94, one end connection section being attached to one end of the centre grip section, the other end connection section being connected to the other end of the centre grip section. The handle 4 is connected to the rear of the body 2 by the two end connection sections 92, 94. The rear handle is constructed from a plastic clam shell 100 and a rear end cap 102 which is attached to the clam shell 100 using screws (not shown). The rear of the body is formed by three plastic clam shells 6, 70, 72 which attach to each other and to the remainder of the body 2 using screws (not shown).

An SDS tool holder 8 is mounted onto the front 10 of the body 2. The tool holder can hold a cutting tool 12, such as a drill bit. A motor (shown generally by dashed lines 48) is mounted within the body 2 which is powered by a mains electricity supply via a cable 14. A trigger switch 16 is mounted on the rear handle 4. Depression of the trigger switch 16 activates the motor in the normal manner. The motor drives a hammer mechanism (shown generally by dashed lines 46 in FIG. 1), which comprises a flat piston 204 reciprocatingly driven by the motor via a con rod 206 within a hollow spindle 150, which in turn reciprocatingly drives a ram 152 via an air spring 170 which in turn strikes, via a beat piece 156, the end of the cutting tool 12. The motor can rotationally drive the hollow spindle 150 via a bevel gear 200 and torque clutch 202. A mode change mechanism (not shown) can switch the hammer drill between three modes of operation, namely hammer only mode, drill only mode or hammer and drill mode. A rotatable knob 18 is mounted on the top of the body 2. Rotation of the knob 18 changes the mode of operation of the hammer drill in well-known manner.

Referring to the FIG. 2, the hollow spindle 150 has a longitudinal axis 154. In side of the hollow spindle 150 is located the ram 152, forward of the flat piston 204, a beat piece 156, forward of the ram 152, a ram catcher located between the ram 152 and the beat piece 156 and a beat piece support structure.

The forward end 162 of the hollow spindle 150 forms part of the tool holder 8. During normal use, the cutting tool 12 (shown in dashed lines in FIG. 2) is held within the forward end 162 of the spindle 50 by the tool holder. The cutting tool 12 is prevented from rotating relative to the spindle 50 whilst being capable of moving axially over a limited range of movement within the forward end 162 of the hollow spindle 150 in well known manner.

The flat piston 204 is mounted directly in the rear of the hollow spindle 150 and comprises an O ring 208 which locates in a groove formed around the main body of the flat piston and which provides an air tight seal between the flat piston and the inner wall of the hollow spindle 150.

The ram 152 is mounted directly in the hollow spindle 150 and comprises a main body 166 attached to an end cap 160, via a neck 168, of smaller diameter than the main body 166 of the ram 152, located at the forward end of the ram 152. The ram is circular in cross section in any plane which extends perpendicularly from the longitudinal axis 154 (which is co-axial with the longitudinal axis of the hollow spindle 150 when the ram is located inside of the spindle) of the ram 152 along its length. The ram 152 comprises an O ring 158 which locates in a groove formed around the main body 166 of the ram and which provides an air tight seal between the ram 152 and the inner wall of the hollow spindle 150. During normal operation of the hammer, the ram 152 is reciprocatingly driven by the flat piston 204 via an air spring 170 formed between the flat piston 204 and ram 152 in well known manner along the longitudinal axis 154. The air spring 170 between the ram 152 and the flat piston 204 is maintained by the air in the air spring 170 being prevented from escaping from (or air external of the air spring entering into) the space between the flat piston 204 and ram 152 due to the two O rings 208, 158.

The ram catcher comprises a rubber ring 214 which locates against the inner wall of the hollow spindle 150 and is axially held in position inside of the spindle by being sandwiched between a ring retainer, comprising a circlip 216 and metal washer 218, and a metal tubular insert 210 of the beat piece support structure, both being located inside of the hollow spindle 150. The rubber ring 214 provides a lip which projects radially inwardly into hollow spindle 150 towards the longitudinal axis 154. The diameter of the aperture formed by the rubber ring 214 is less than that of the end cap 160 of the ram 152 but similar to that of the neck 168 of the ram 152. A series of holes 220 are formed around the circumference of the spindle rearward of the circlip 216 which each extend through the wall of the hollow spindle 150.

During the normal operation of the hammer drill, when the cutting tool is engaged with a work piece, the ram 152 is reciprocatingly driven over a range of axial positions (one of which is shown in FIG. 2) inside of the spindle located to the rear of the ram catcher, the ram 152 being prevented from engaging the ram catcher due to the position of the beat piece 156. The ring 214 has no contact with any part of the ram 152 during the normal operation of the tool. When the ram 152 is able to move forward, due to the position of the beat piece, the end cap 160 engages with the rubber ring 214 and passes through the aperture due to the ring deforming, allowing the lip to flex to enable the cap 160 to pass through it. Once the cap 160 has passed through the ring 214, the lip returns to its original shape, locating in the neck 168 of the ram to hold the ram 152 stationary (as shown in FIGS. 3 and 4).

The beat piece 156 is supported by a beat piece support structure formed in part by the hollow spindle 150 and in part by a support structure inside the hollow spindle 150 comprising a metal tubular insert 210 sandwiched between an O ring 212 and the rubber ring 214 of the ram catcher. The beat piece 156 is circular in cross section in any plane which extends perpendicularly from the longitudinal axis 154 (which is co-axial with the longitudinal axis of the hollow spindle 150 when the beat piece is located inside of the spindle) of the beat piece 156 along its length, the centre of the circular cross section being located on the longitudinal axis.

The beat piece 156 comprises a middle section 172, a front section 174 and a rear section 176.

The middle section 172 has a uniform diametered circular cross section along its length, the centre of the circular cross section being located on the longitudinal axis 154.

The rear section 176 has a uniform diametered circular cross section along its length, the centre of the circular cross section being located on the longitudinal axis 154. The rear end 240 of the rear section 176 is flat and is impacted by the cap 160 of the ram 152 during normal operation. The rear section 176 is joined to the middle section 172 via a first angled region 242. The first angled region 242 engages with a correspondingly shaped first angled shoulder 244 formed on the metal insert 210 located inside the spindle when the beat piece is in its most rearward position, limiting the amount of rearward movement of the beat piece 156. The wall of the angled shoulder 244 is circular in cross section in any plane which extends perpendicularly from the longitudinal axis 154 of the hollow spindle 150, the centre of the circular cross section being located on the longitudinal axis. When the first angled region 242 is in engagement with the first angled shoulder 244, there is a uniform amount of contact between the two surfaces around the longitudinal axis 154.

The front section 174 is frusto-conical in shape centred around the longitudinal axis 154 of the beat piece 156. The front end 246 of the front section 174 is flat and impacts the cutting tool 12 during normal operation. The front section 174 is joined to the middle section 172 via a second angled region 248 which is frusto-conical in shape centred around the longitudinal axis 154 of the beat piece 156. The second angled region 248 engages with a correspondingly shaped second angled shoulder 250 formed on the inner wall of the hollow spindle 150 when the beat piece is in its most forward position, limiting the amount of forward movement of the beat piece 156. The wall of the second angled shoulder 250 is circular in cross section in any plane which extends perpendicularly from the longitudinal axis 154 of the hollow spindle 150, the centre of the circular cross section being located on the longitudinal axis 154. When the second angled region 248 is in engagement with the second angled shoulder 250, there is a uniform amount of contact between the two surfaces around the longitudinal axis 154.

When the hammer drill is operating in the normal manner with the cutting tool 12 cutting a work piece, the ram strikes the beat piece 156 which in turn strikes the end of cutting tool 12 in the tool holder 8. The ram 152 is reciprocatingly driven over a limited range of axial movement within the spindle, the maximum distance from the flat piston being limited by the position of the beat piece 156 which it impacts, the position of which in turn is controlled by the end of the cutting tool 12. Whilst traveling within this range of axial movement, the O ring 158 of the ram 152 does not pass the holes 220. As such, the air spring 170 between the flat piston 204 and ram 152 is maintained. The rear section 176 projects rearwardly through the aperture of the ring 214 of the ram catcher, to enable the cap 160 of the ram 152 to strike it as shown in FIG. 2.

When the cutting tool 12 is removed from the work piece, the beat piece 156 is able to move forward as the cutting tool 12 can extend out of the tool holder 8 to its maximum position. If the motor is still running, the flat piston 204 is able to drive the ram 152 via the air spring 170 further along the hollow spindle 150, as the beat piece 156 can move forward, passing the air holes 220. Once the O ring 158 of the ram 152 has passed the air holes 220, the air is able to freely pass into and out of the hollow spindle 150 in the space between the flat piston 204 and ram 152, causing the air spring 170 to be broken and thus disconnecting the drive between the flat piston 204 and ram 152. As the air spring 170 is broken, the ram 152 is able freely continue to travel along the length of the hollow spindle 150. The ram 152 engages with the ram catcher, the cap 160 passing through the ring 214 allowing the neck 168 to engage with the ring, to secure the ram in the ram catcher, as seen in FIGS. 3 and 4. The reciprocating movement of the flat piston 204 has no effect on the ram 152 as the air spring 170 is broken due to the holes 220 which allow air in and out of the spindle 170 in the space between the flat piston 204 and ram 152. The beat piece 156 is pushed forward in the hollow spindle 150 by the ram 152 in the ram catcher. In order to release the ram 152 from the ram catcher, the cutting tool 12 is pressed against a work piece causing it to be pushed into the tool holder 8, which in turn pushes the beat piece 156 rearwardly into engagement with the cap 160 of the ram 152, pushing it out of the ram catcher and past the holes 220. In such a position, the air spring 170 is reformed and the flat piston 204 is able to reciprocatingly drive the ram 152 again.

In existing designs of hammer mechanism which use a con rod, the con rod is made from plastic or aluminium. If it is made from plastic, it can deform particularly when exposed to heat due to the operation of the hammer drill. If the con rod is made from aluminium, it is subject to failure if it is not lubricated properly with oil and/or grease.

### SUMMARY

Accordingly, there is provided a con rod for a hammer drill characterized in that the con rod is made from sintered steel.

The used of sintered steel to manufacture a con rod enables the density of the steel in the con rod to be controlled which in turn allows for the weight of the con rod to be adjusted and optimized when compare with other components of the hammer mechanism such as the piston. Optimizing the weight of the cranks shaft is important as it effects the forces experienced by the reciprocating drive mechanism for the piston as it reciprocatingly drives the piston within the cylinder. This in turn effects the amount of vibration generated by the hammer mechanism. Furthermore, manufacturing the con rod from sintered steel provides a higher compressive strength than a con rod made from either aluminum or plastic and provides better resilience to higher temperature than a con rod made from either aluminum or plastic, and is subject to fewer mechanical failures than a con rod made from either aluminum or plastic.

Manufacturing a con rod from sintered steel also has the advantage of providing a sinter effect with a porosity for accommodating grease and/or oil for improved lubrication. The con rod may be impregnated with the lubricant such as grease and/or oil. The porosity of the sintered steel con rod allows lubricants to flow through the con rod and/or remain captured within the con rod.

The captured grease and/oil within the con rod improves the lubrication of the con rod where it pivotally connects to a crank plate and piston by reducing the frictional contact which in turn provides a smoother movement. This reduces heat and vibration generated by the operation of the con rod.

Similar benefits and advantages can be gained when a wobble plate is used within a hammer mechanism and some or all of the component parts are made from sintered steel.

Accordingly, in an embodiment of the invention, a hammer drill is provided including a housing; a tool holder mounted on the housing and configured to hold a cutting tool; a motor mounted within the housing; and a hammer mechanism. The hammer mechanism in turn includes a crank plate; a con rod pivotally connected at a first end to the crank plate, the con rod being made of sintered steel in a one-piece construction; a piston slidably mounted in the housing and reciprocatingly driven along a longitudinal axis by the motor via the crank plate and con rod, wherein a second end of the con rod is pivotally connected to the piston; a ram mounted in the housing forward of the piston that is reciprocatingly driven along the longitudinal axis by the piston via an air spring; and a beat piece supported in an axially sliceable manner along the longitudinal axis within a beat piece support structure, wherein during the normal operation of the hammer mechanism, the beat piece is repetitively struck by the ram and transfers impact energy to the cutting tool.

Alternatively, in an embodiment, a hammer drill is provided including a housing; a tool holder mounted on the housing and configured to hold a cutting tool; a motor mounted within the housing; and a hammer mechanism. The hammer mechanism in turn includes a wobble plate driven by the motor, the wobble plate being at least partially made of sintered steel; a con rod pivotally including a first end coupled to the crank plate and a second end; a piston slidably mounted in the housing and coupled to the second end of the con rod, the piston being reciprocatingly driven along a longitudinal axis by the motor via the wobble plate and the con rod; a ram mounted in the housing forward of the piston that is reciprocatingly driven along the longitudinal axis by the piston via an air spring; and a beat piece supported in an axially sliceable manner along the longitudinal axis within a beat piece support structure, wherein during the normal operation of the hammer mechanism, the beat piece is repetitively struck by the ram and transfers impact energy to the cutting tool.

Other embodiments and optional details of the invention are described in the detailed description below and in the claims.

### BRIEF DESCRIPTION OF THE DRAWINGS

The drawings described herein are for illustrative purposes only of selected embodiments and not all possible implementations and are not intended to limit the scope of the present disclosure.

FIG. 1 shows a sketch of a side view of a prior art hammer drill;

FIG. 2 shows a cross sectional view of the hammer mechanism with the ram in a position where it can freely slide within the spindle;

FIG. 3 shows a cross sectional view of the hammer mechanism with the ram in the ram catcher and the beat piece sliding in the spindle;

FIG. 4 shows a cross sectional view of the hammer mechanism with the ram in the ram catcher and the beat piece in its furthest forward position in the spindle;

FIG. 5 shows the beat piece;

FIG. 6 shows a vertical cross-sectional view of a hammer drill in accordance with a first embodiment the present invention;

FIG. 7 shows a rear view of the piston shown in FIG. 6;

FIG. 8 shows a side view of the piston shown in FIG. 6;

FIG. 9 shows a rear perspective view of the piston shown in FIG. 6;

FIG. 10 shows a front perspective view of the piston shown in FIG. 6;

FIG. 11 shows a side view of the con rod of FIG. 6;

FIG. 12 shows a cross sectional view of the con rod in the direction of Arrows A in FIG. 11;

FIG. 13 shows a cross sectional view of the con rod in the direction of Arrows B in FIG. 11; and

FIG. 14 shows a second embodiment of the present invention.

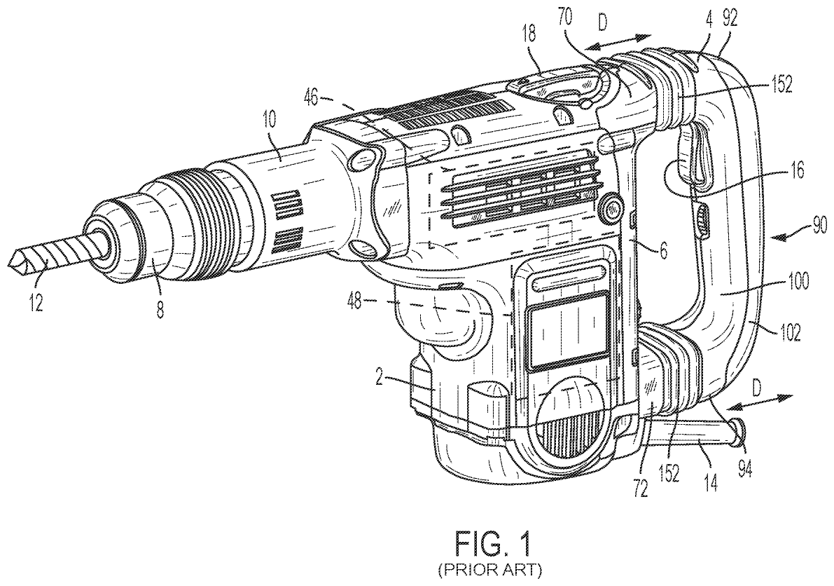

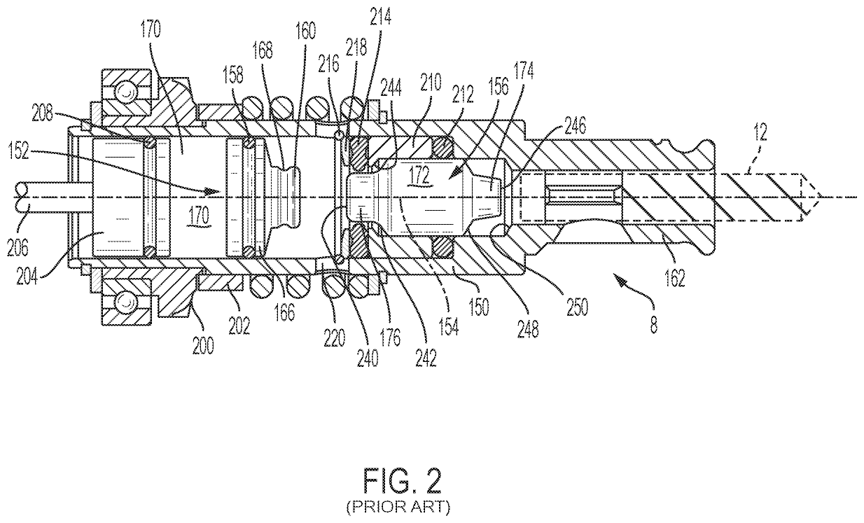

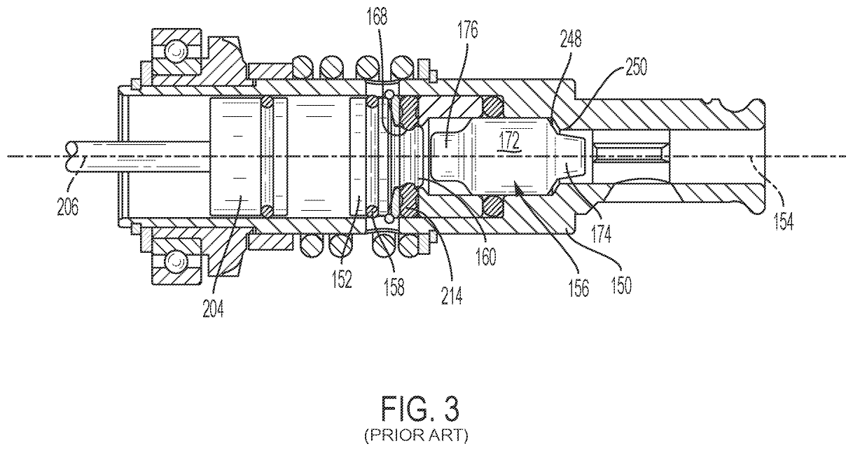

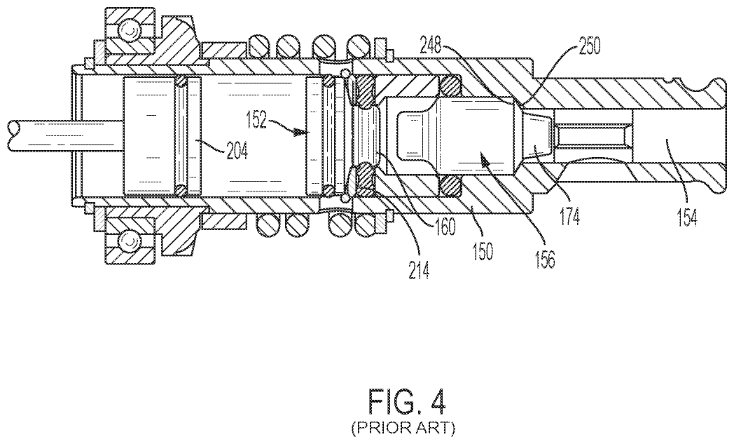

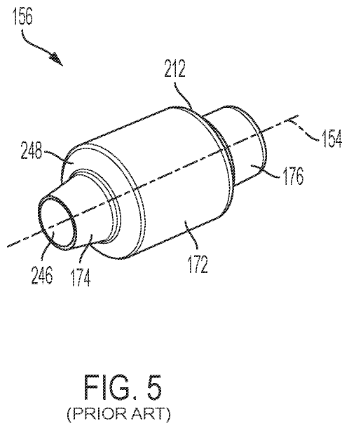

Corresponding reference numerals indicate corresponding parts throughout the several views of the drawings.

### DETAILED DESCRIPTION

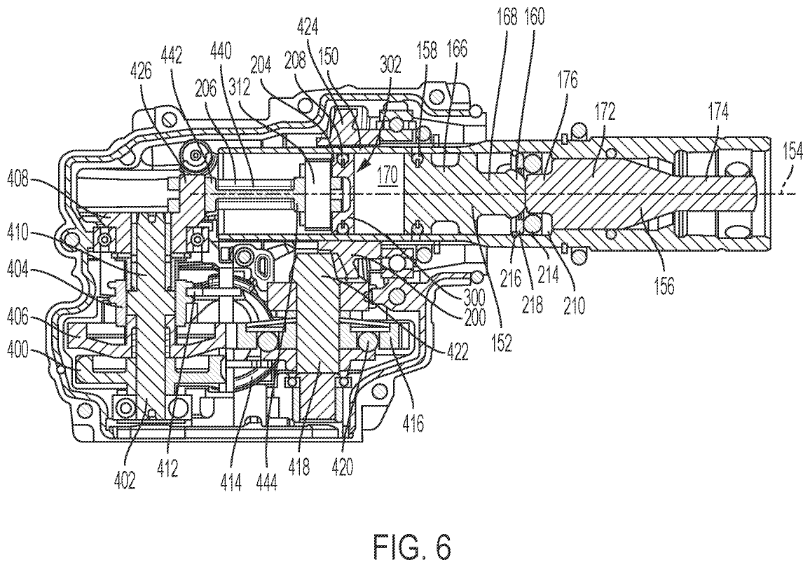

Two embodiments of the present invention will now be described with reference to FIGS. 6 to 14.

FIG. 6 shows a cross section view of hammer drill having a con rod in accordance with a first embodiment of the present invention. Where the same features in the embodiment shown in FIG. 6 are shown in the prior art example described above, the same reference numbers are used and the same description is applicable. The main difference between the prior art design and the embodiment is the design of the con rod 206, the piston 204 and hollow spindle 150.

Referring to FIG. 6, the hammer mechanism comprises a first gear 400 rotationally driven by an electric motor (not shown). The first gear 400 is rigidly attached to a first spindle 402 such rotation of the first gear 400 results in rotation of a spindle 402.

A second gear 406 is mounted on the first spindle 402 adjacent the first gear. The second gear 406 is axially fixed on the first spindle 402 but can freely rotate around the first spindle 402. A crank plate 408 is mounted on a top end of the first spindle 402. The crank plate 408 is axially fixed on the spindle but can freely rotate around the end of the spindle 402.

A sleeve 404 is mounted on the spindle 402 and surrounds a splined section 410 of the first spindle 402. The inner part of the sleeve 404 comprises corresponding splines which engage with the splines of the spindle 402. The sleeve 404 can axially slide along the first spindle 402 but is rotationally fixed to the first spindle 402 via the meshing splines so that rotation movement of the sleeve 404 always results in rotational movement of the spindle 402. The sleeve 404 can slide vertically between three positions; a lower position where it in driving engagement with spline section 410 and the second gear 406 only; a middle position where it is driving engagement with the spline section 410, the second gear 406 and the crank plate 408; and an upper position where it in driving engagement with the spline section 410 and the crank plate 408 only. The sleeve 404 is moved between its three positions via a mode change mechanism 412 which is operated using a mode change knob 414.

The second gear 406 is in driving engagement with a third gear 416 which is mounted on a second spindle 418. Rotation of the second gear 406 results in rotation of the third gear 416. The third gear 416 is axially fixed on the second spindle 418. The third gear 416 is rotationally fixed to the second spindle 418 via a torque clutch 420 so that rotation of the third gear 416 results in rotation of the second spindle 418 if the torque across the torque clutch 420 is below a pre-set value and that rotation of the third gear 416 results in rotation of the third gear 416 around the second spindle 418 if the torque across the torque clutch is above a pre-set value with the second spindle remaining stationary.

A first bevel gear 422 is formed on the top end of the second spindle 418, the first bevel gear 422 is in driving engagement with a second bevel gear 424 which surround and is rigidly connected to the hollow spindle 150. Rotation of the second spindle 418 results in rotation of the hollow spindle 150 via the bevel gears 422, 424.

The crank plate 408 has an eccentric pin 426 integrally formed on the top of the crank plate 408. The longitudinal axis of the eccentric pin 426 is parallel to but offset from longitudinal axis of the first spindle 402 such rotation of the first spindle 402 results in the eccentric pin 426 rotating around the longitudinal axis of the first spindle 402, the eccentric pin 426 moving back and forwards as well as side to side as it does so. A con rod 206 connects between the eccentric pin 426 and the piston 204 inside of the hollow spindle. Rotation of the crank plate 308 results in the reciprocation of the piston 204 within the hollow spindle 150.

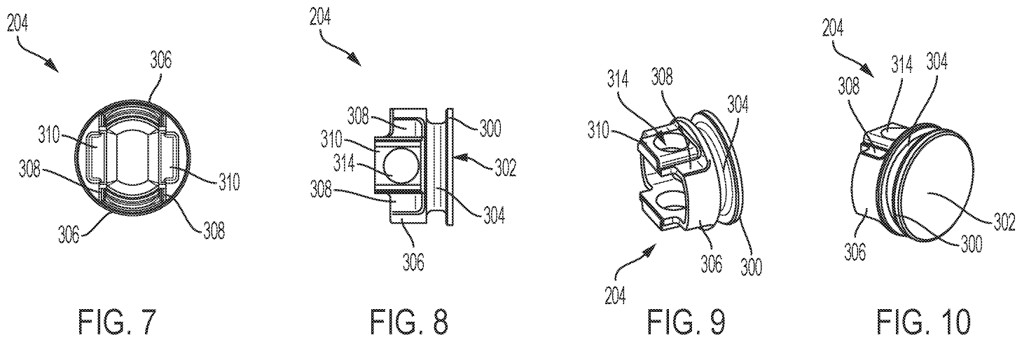

Referring to FIGS. 7 to 10, the piston 204 is a flat piston and comprises a front circular disk 300 having flat front surface 302. A circumferential groove 304 extends around the edge of the circular disk 300. A circular peripheral wall 306 extends rearwardly from the edge of the circular disk 300, perpendicularly to the plane of the circular disk 300. Two straight sections 308 are formed on two opposite sides of the wall 306. A frame 310 is formed on each straight section 308. An aperture 314 is formed through each frame 310 and straight section 308. The piston 204 is manufactured in a one-piece construction from sintered steel which has been impregnated with a lubricant such as grease and/or oil.

The rubber O ring 208 locates in the groove 304. The piston 204 is mounted inside of the hollow spindle 150 and connected to the con rod 206 via a cross pin 312.

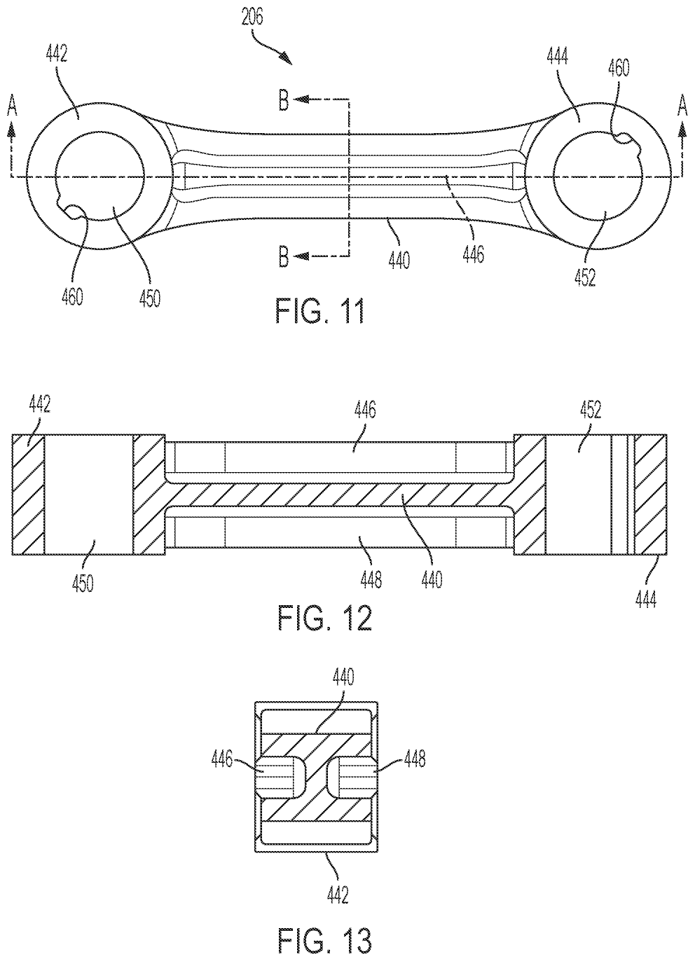

The con rod 206 is shown in more detail in FIGS. 11 to 13. The con rod comprises a central section 440 which interconnects two end ring sections 442, 444. The central section 440 is of rectangular cross section with an elongate groove 446, 448 extending in a lengthwise direction along each of the sides of the central section 440. Each end ring section comprises a circular aperture 450, 452. One end section 442 connects to the eccentric pin 426, the eccentric pin 426 locating inside of the circular aperture 450 of the end section 442. The other end section 444 connects to the cross pin 312 for the piston 204, the cross pin 312 locating inside of the circular aperture 452 of the end section 444. A semi-circular groove 460 is formed in the side wall of each aperture 450, 452 along the length of the apertures 450, 452. The con rod 206 is manufactured in a one-piece construction from sintered steel which has been impregnated with a lubricant such as grease and/oil. The impregnated lubricant reduces the friction between the con rod 206 and the eccentric pin 426 and cross pin 312 as the eccentric pin 426 and cross pin 312 pivot within the apertures 450, 452 during the operation of the hammer mechanism. The semi-circular grooves 460 enable addition additional lubrication to enter the apertures 450, 452 and engage with the surfaces of the apertures 450, 452, eccentric pin 426 and cross pin 312 making friction contact.

It will be appreciated that the eccentric pin 426 and/or cross pin 312 could be manufactured in a one-piece construction from sintered steel which has been impregnated with a lubricant such as grease and/or oil. This would further help lubrication to reduce the frictional contact. If the eccentric pin 426 and crank plate 408 are manufactured in one-piece construction, then both of these can be manufactured in a one-piece construction from sintered steel which has been impregnated with a lubricant such as grease and/or oil.

The design of the hollow spindle 150 is manufactured from steel. The coefficient of expansion of the steel hollow spindle 150 is the same as that of the sintered flat piston 204.

Alternatively, the hollow spindle 150 is manufactured from sintered steel. Ideally, it would be manufactured in a one-piece construction. The coefficient of expansion of the sintered steel hollow spindle 150 is the same as that of the sintered flat piston 204. The sintered steel hollow spindle 150 can impregnated with a longitudinal axis of the first spindle lubricant such as grease and/oil.

The sintered con rod 206, the sintered steel piston 204 and/or the sintered steel hollow spindle 150 can be manufactured by using a sintering process and then submersing them in a lubricant, such as a grease and/or oil, to impregnate the con rod and/or piston and/or spindle with the lubricant.

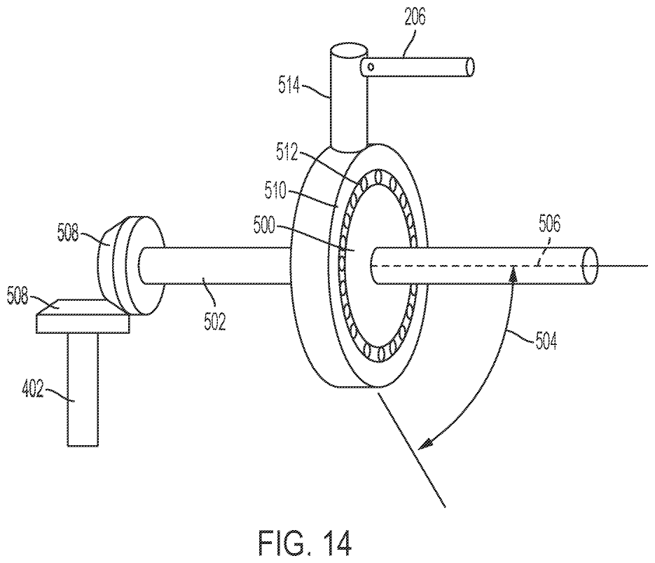

A second embodiment of the present invention will now be described with reference to FIG. 14. Where the same features in the second embodiment are present in the first embodiment, the same reference numbers have been used. The difference between the first embodiment and the second embodiment is that the crank plate and eccentric pin have been replaced with a wobble plate.

The wobble plate comprises a circular central plate 500 mounted on a shaft 502, the plane of the plate 500 being located at an angle 504 relative to a longitudinal axis 506 of the shaft 502. The shaft 502 is driven by the first spindle 402 via set of bevel gears 508. A circular ring 510 is mounted on the plate 500 via a bearing 512 and surrounds the periphery of the plate 500 such that plane of the ring 510 is parallel to the plane of the plate 500. The ring 510 can freely rotate around the periphery of the plate 500. The ring 510 is prevented from rotating. Therefore, as the shaft 502 rotates, the plane of the plate 500 oscillates back and forth in the direction of the longitudinal axis 506 of the shaft 502. A finger 514 is attached to the side of the ring 510 and extends radially away from the centre of the ring 510. The end of the finger 514 remote from the ring 510 is attached to the rear of the piston 204 via a con rod 206. As the shaft 502 rotates and the plane of the plate 500 oscillates back and forth in the direction of the longitudinal axis 506 of the shaft 502, the finger 514 also oscillates back and forth in the direction of the longitudinal axis 506 of the shaft 502, reciprocatingly driving the piston 204.

The ring 510 and finger 514 is manufactured in a one-piece construction from sintered steel which has been impregnated with a lubricant such as oil. The impregnated lubricant reduces the friction between the ring 510 and the bearing 512 and between the finger 514 and the con rod 206. The plate and shaft can also be manufactured in a one-piece construction from sintered steel which has been impregnated with a lubricant such as oil. With the reduction in friction, it will be appreciated that the bearing 512 can be omitted, with the ring 510 being directly rotationally mounted on the plate 500.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

1-12. (canceled)

13. A hammer drill comprising:
a housing;
a tool holder mounted on the housing and configured to hold a cutting tool;
a motor mounted within the housing; and
a hammer mechanism comprising:
a wobble plate driven by the motor, the wobble plate being at least partially made of sintered steel;
a con rod pivotally including a first end coupled to the crank plate and a second end;
a piston slidably mounted in the housing and coupled to the second end of the con rod, the piston being reciprocatingly driven along a longitudinal axis by the motor via the wobble plate and the con rod;
a ram mounted in the housing forward of the piston that is reciprocatingly driven along the longitudinal axis by the piston via an air spring; and
a beat piece supported in an axially sliceable manner along the longitudinal axis within a beat piece support structure, wherein during the normal operation of the hammer mechanism, the beat piece is repetitively struck by the ram and transfers impact energy to the cutting tool.

14. The hammer drill of claim 13, wherein the wobble plate comprises:
a circular central plate;
a ring mounted on the circular central plate that surrounds a periphery of the circular central plate such a plane of the ring is parallel to a plane of the circular central plate, the ring being able to freely rotate around the periphery of the circular central plate; and
a finger attached to a side of the ring and extending radially away from a centre of the ring;
wherein at least one of the circular central plate, the ring, or the finger is made from sintered steel.

15. The hammer drill of claim 14, wherein at least one of the circular central plate, the ring, or the finger is impregnated with a lubricant.

16. The hammer drill of claim 15, wherein the lubricant is at least one of oil or grease.

17. The hammer drill of claim 13, wherein the con rod is made of sintered steel in a one-piece construction.

18. The hammer drill of claim 17, wherein the con rod comprises a central section that interconnects two end ring sections,
wherein the central section includes a rectangular cross-section with an elongate groove extending in a lengthwise direction along each of the sides of the central section, and
wherein each of the two end ring sections comprises a circular aperture.

19. The hammer drill of claim 18, wherein the con rod comprises a semi-circular groove formed in a side wall of at least one of the apertures of the two end sections.
